(19) United States
(12) Patent Application Publication
(10) Pub. No.: US 2017/0262866 A1
(43) Pub. Date: Sep. 14, 2017

(54) PERFORMING AUTOMATED OPERATIONS BASED ON TRANSACTIONAL DATA

(71) Applicant: Amplero, Inc., Seattle, WA (US)

(72) Inventors: Philip Webster Barker, Issaquah, WA (US); Garrett Frank Tenold, Seattle, WA (US); Oliver B. Downs, Redmond, WA (US)

(21) Appl. No.: 15/610,477

(22) Filed: May 31, 2017

Related U.S. Application Data
(63) Continuation of application No. 14/267,330, filed on May 1, 2014.

(51) Int. Cl. G06Q 30/02

(52) U.S. Cl. CPC G06Q 30/02; G06Q 30/0204

(57) ABSTRACT

Subject innovations are directed towards a platform architecture, system, and special purpose software and hardware that employs a machine learning approach using transactional behavioral events and data about customers to allow a telecommunications marketer to express a set of configurable business rules and constraints, and within a dynamic optimization approach, derive solutions or marketing approaches to optimize delayed key performance indicators. In one embodiment, this is obtained using marketing experiments that seek to learn and influence long term behaviors of customers.

### TECHNICAL FIELD

The present invention relates generally to computing program architecture and, more particularly, but not exclusively to a computer program using a special purpose hardware platform to perform contextual marketing based in part on transactional behavioral data.

### BACKGROUND

The dynamics in today's telecommunications market are placing more pressure than ever on networked services providers to find new ways to compete. With high penetration rates and many services nearing commoditization, many companies have recognized that it is more important than ever to find new ways to bring the full and unique value of the network to their customers. In particular, these companies are seeking new solutions to help them more effectively up-sell and/or cross-sell their products, services, content, and applications; successfully launch new products; and create long-term value in new business models.

There also is a desire by many telecommunication providers to deepen their engagement with their customers, and provide an improved customer experience. They seek to increase the value that their customers receive, and to extend their long term value. By doing so, it is expected that such actions may increase customer loyalty, and thereby result in increased revenue. Therefore many vendors continue to seek better approaches to marketing their products to their customers that include addressing the changing market. Thus, it is with respect to these considerations and others that the present invention has been made.

### BRIEF DESCRIPTION OF THE DRAWINGS

Non-limiting and non-exhaustive embodiments are described with reference to the following drawings. In the drawings, like reference numerals refer to like parts throughout the various figures unless otherwise specified.

For a better understanding, reference will be made to the following Detailed Description, which is to be read in association with the accompanying drawings, wherein:

FIG. 1 is a system diagram of one embodiment of an environment in which the techniques may be practiced;

FIG. 2 shows one embodiment of a client device that may be included in a system implementing the techniques;

FIG. 3 shows one embodiment of a network device that may be included in a system implementing the techniques;

FIG. 4 shows one embodiment of a contextual marketing architecture employing a contextual marketing manager (CMM) within a contextual marketing platform (CMP);

FIG. 5 shows one embodiment of an intake & event manager usable within the CMP of FIG. 4;

FIG. 6 shows one embodiment of an attribute & state vector manager usable within the CMP of FIG. 4;

FIG. 7 shows one embodiment of the contextual marketing manager usable within the CMP of FIG. 4;

FIG. 8 shows one embodiment of a component usable within the CMM of FIG. 7 to perform treatment eligibility;

FIG. 9 shows one embodiment of a component usable within the CMM of FIG. 7 to perform ranking of eligibilities;

FIG. 10 shows one embodiment of a component usable within the CMM of FIG. 7 to perform a decider process;

FIG. 11 shows one embodiment of a component usable within the CMM of FIG. 7 to perform decision attribute computations; and

FIG. 12 shows one embodiment of a component usable within the CMM of FIG. 7 to perform message actions.

### DETAILED DESCRIPTION

The present techniques now will be described more fully hereinafter with reference to the accompanying drawings, which form a part hereof, and which show, by way of illustration, specific embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The various occurrences of the phrase “in one embodiment” as used herein do not necessarily refer to the same embodiment, though they may. As used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the terms “customer,” “user,” and “subscriber” may be used interchangeably to refer to an entity that has or is predicted to in the future make a procurement of a product, service, content, and/or application from another entity. As such, customers include not just an individual or a family, but also businesses, organizations, or the like. Further, as used herein, the term “entity” refers to a customer, subscriber, user, or the like. In one embodiment, an entity may also be a subscriber telecommunications line or simply, a subscriber line.

As used herein, the terms “networked services provider”, “telecommunications”, “telecom”, “provider”, “carrier”, “telecommunications service provider,” and “operator” may be used interchangeably to refer to a provider of any network-based telecommunications media, product, service, content, and/or application, whether inclusive of or independent of the physical transport medium that may be employed by the telecommunications media, products, services, content, and/or application. As used herein, references to “products/services,” or the like, are intended to include products, services, content, and/or applications, and is not to be construed as being limited to merely “products and/or services.” Further, such references may also include scripts, or the like.

As used herein, the terms “optimized” and “optimal” refer to a solution that is determined to provide a result that is considered closest to a defined criteria or boundary given one or more constraints to the solution. Thus, a solution is considered optimal if it provides the most favorable or desirable result, under some restriction, compared to other determined solutions. An optimal solution therefore, is a solution selected from a set of determined solutions.

As used herein, the terms “offer” and “offering” refer to a networked services provider's product, service, content, and/or application for purchase by a customer. In one embodiment, an offer may be viewed as a stated condition to be met by a customer or subscriber in exchange for an incentive. An offer or offering may be presented to the customer (user) using any of a variety of mechanisms. Thus, the offer or offering may be independent of the mechanism by which the offer or offering is presented.

As used herein, the term “rule” refers to associating an attribute with an operation and a value. A “rule set” refers to a collection of rules, that may include strategies that can be deployed to a customer or subscriber.

As used herein, the term “message” refers to a mechanism for transmitting an offer or offering. Typically, the offer or offering is embedded within a message having a variety of fields. The fields may include how the message is presented, when the message is presented, or the like. Thus, in some embodiments, a field of a message having the offer may include the mechanism in which the offer is presented. For example, in some embodiments, a message having the offer may be selected to be sent to a user/customer based on a field for how the offer is presented (e.g., voice, IM, email, or the like), or when it is presented.

Moreover, because the offer may have various fields, those offer fields may be grouped and collectively herein referred to as message fields, as well. For example, the offer may include a discount field, a tone of voice field, an urgency field, or the like, each of which may be collectively assigned as fields of the message (which includes the offer and its fields).

As used herein, the term “event” refers to a piece of information that has an associated point in time and relates to an entity. As one non-limiting, non-exhaustive example, a phone recharge may be considered as an event. Events may be delivered to the platform described herein, via a telecommunications service provider as customer specific events; be defined based on a mapping of customer specific events; be defined by processes within the CMP; or the like.

As used here, the term “feature measure” refers to an outcome or result of an action (or non-action) for which a marketer may wish to observe and/or otherwise influence based on some input. For example, a marketer may wish to determine whether offering a discount on some product results in an increase in purchases. In this non-exhaustive, non-limiting example, the feature measure would be purchases. However, marketers may also like to influence a variety of other feature measures, including, but not limited to Average Revenue Per User (ARPU), Active Base Percentage (ABP), Average Revenue Per Paying User (ARPPU), average margin per user (AMPU), average data consumption per user (ADCPU), or a variety of other outcomes.

As used herein, the term “Key Performance Indicators or (KPI)” refers to one or more feature measures or metrics for which a line of business seeks to optimize upon. “Delayed KPIs” refer to those feature measures or metrics for which there may be a significantly measureable delay in time between injecting or providing a stimulus for an action, before a result from that action is observable and thereby measurable. Non-limiting examples of delayed key performance indicators might be whether a customer stays with the provider after three months of injecting or providing the stimulus for the action; whether the customer renews a product or service within three months of injecting or providing the stimulus for the action; whether the customer makes a purchase within two months of injecting or providing the stimulus for the action; or the like. Other durations may also be possible.

As used herein, the terms “target,” and “target group,” refer to a composition of users that are subjected to some action for which a resulting feature measure is to be observed. The target group may sometimes be referred to as a “test group.” A “target distribution,” then may be a graph or representation of a feature measure result for the target group. Similarly, the terms “control,” and “control group,” refer to a composition of users that do not receive the action that the target group is subjected to. A “control distribution,” then may be a graph or other representation of the feature measure result for the control group.

As used herein, the term “attribute” refers to a characteristic that can be computed or otherwise obtained about one or more entities, messages, or other item. User attributes, include, but are not limited to, an user's age; a geographic location of the user; an income status of the user; a usage plan; a plan identifier (ID); a refresh rate for the plan; a user propensity (e.g., a propensity to perform an action, or so forth) or the like. Attributes may also include or otherwise represent information about user clusters, including recharge (of a mobile device) time series clusters, usage histogram clusters, cluster scoring, or the like. Thus, attributes may include a variety of information about users. In some embodiments, the attributes may have discrete values, continuous values, values constituting a category, cyclical values, or the like. Moreover, some attributes may be recursive, being derived from other attributes. In some embodiments, a user might not include at least one attribute (missing attribute) for which another user might include. The set of attributes about an entity may be combined to create an ordered set of attributes herein termed a “state vector.”

As used herein, the term “eligibility” refers to a determination that an entity can receive an offer, typically using attributes for a given entity and marketing configuration. As used here, the term “treatment,” refers to a combination of a marketing or business strategy, user experience, and context. That is, a unique list of user experiences per strategy per rules that uniquely qualify a subscriber for an experience in a given strategy. It is noted then that “treatment eligibility” refers to a treatment that a subscriber is eligible to receive.

As used herein, the terms “marketing experiment” and “experiment” refer to a collection of user experiences that are being tested and/or monitored for impact to the optimization of one or more KPIs and/or one or more delayed KPIs across a subset or a full set of subscribers in a telecommunications service provider's customer population. In some embodiments, an experiment is constructed to learn about new experience impact on one or more KPIs. In some embodiments, an experiment is constructed to monitor on-going efficacy of existing experience impact on one or more KPIs. However, such examples of use of an experiment are not to be construed as limiting the definition; but, instead merely are provided as example applications, and other applications may also be used.

The following briefly describes the embodiments in order to provide a basic understanding of some aspects of the techniques. This brief description is not intended as an extensive overview. It is not intended to identify key or critical elements, or to delineate or otherwise narrow the scope. Its purpose is merely to present some concepts in a simplified form as a prelude to the more detailed description that is presented later.

Briefly stated, subject innovations are disclosed herein that are directed towards at least a platform architecture, system, and special purpose software and hardware that employs a machine learning approach using transactional behavioral events and data about customers/users to allow a telecommunications marketer to express a set of configurable business rules and constraints, and within a constraint optimization approach, derive solutions or marketing approaches to optimize delayed KPIs. In one embodiment, this is obtained using marketing experiments that seek to learn and influence long term behaviors of customers/users.

That is, the innovative platform disclosed herein receives data about users of a telecommunications product or service, including how a product or service is used by the users. The data may be encapsulated into a per user state vector and used to run marketing experiments on a set of the users, which can be any subset up to the entire user population. The experiments may then be managed by the platform to statistical significance, leveraging treatment rankings and eligibilities for the users to optimize one or more delayed KPIs. In one embodiment, optimizing delayed KPIs may include increasing long-term revenue and retention performance for a telecommunications service provider. In at least one embodiment, optimizing delayed KPIs may also positively influence short-term KPIs.

In one embodiment, events and other data about a user that includes transactional behavioral data are received, and common views or a common set of transactional events may be determined and employed to create a standard representation of the data. The data may be stored in a state vector structure that includes attributes about transactions and behaviors for each user. The state vectors may also encode predictions about future user behavior, classifications of a user based on observed behavior and further provide a multi-viewed source of data about the user that may then be presented to a data science interface for arbitrary computations about the user, the results of which can themselves be attributes joined to the existing state vectors to produce new state vectors.

Given the set of business rules and constraints from a marketer, a large set of eligible treatments that may be given to a user may be rank ordered based on predictions for optimizing selectable KPIs. The rank ordered list of eligible treatments for a given user may be evaluated based on historical information about each user, including past treatments, to determine whether the user may validly be subjected to a given treatment. This validation process is directed toward enforcing experimental constraints to ensure that an adaptive experimental design is being maintained by examining possible treatment interactions that may negatively or positively impact a proposed treatment. Based on this validation process, users may then be placed into a marketing experiment. In some embodiments, the validation process might determine that a user not be placed into any marketing experiment. In some embodiments, selected users are subjected to the treatments based on whether they have been placed into a target group or a control group for the experiment. Results of the treatments are then monitored and fed back into the machine learning platform to determine whether a given treatment positively or negatively impacts the KPIs of interest. Thus, the platform disclosed herein is designed to perform marketing experiments on a large scale (often using very large datasets) that adapts and responds automatically based on user behavior over time, and is further directed to drill down automatically into areas of treatments where marketing performance being achieved is determined to be optimal.

It is noted that while embodiments herein disclose applications to telecommunications customers, where the customers are different from the telecommunications providers, other intermediate entities may also benefit from the subject innovations disclosed herein. For example, banking industries, cable television industries, retailers, wholesalers, or virtually any other industry in which that industry's customers interact with the services and/or products offered by an entity within that industry.

### Illustrative Operating Environment

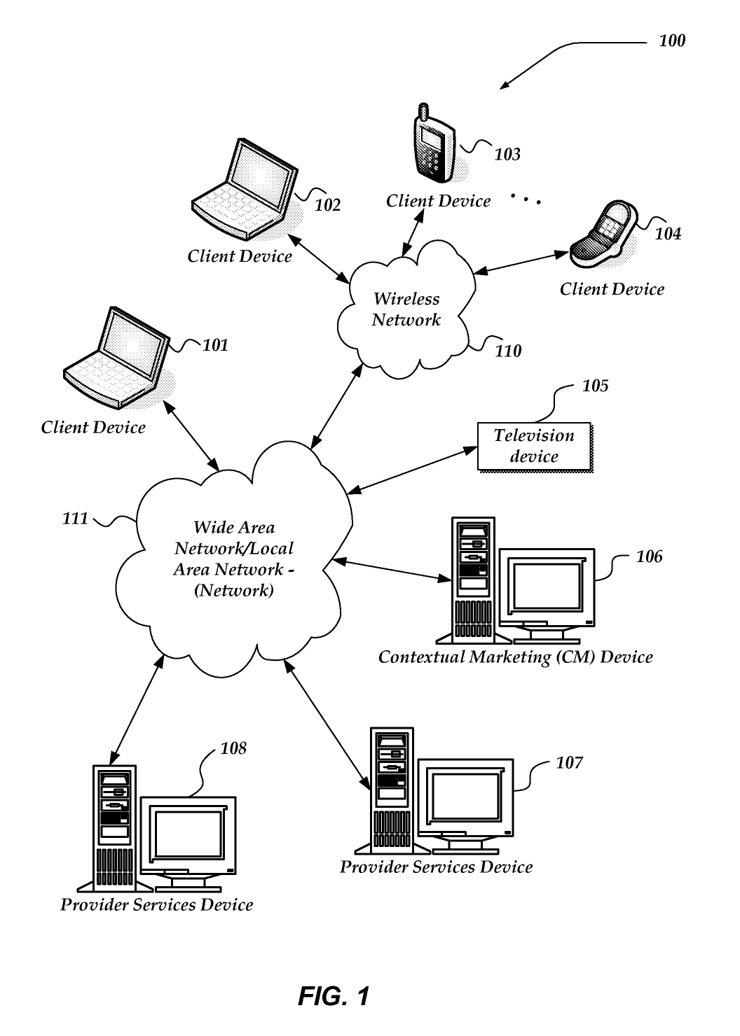

FIG. 1 shows components of one embodiment of an environment in which the invention may be practiced. Not all the components may be required to practice the invention, and variations in the arrangement and type of the components may be made without departing from the spirit or scope of the subject innovations. As shown, system 100 of FIG. 1 includes local area networks (“LANs”)/wide area networks (“WANs”)-(network) 111, wireless network 110, client devices 101-105, Contextual Marketing (CM) device 106, and provider services 107-108.

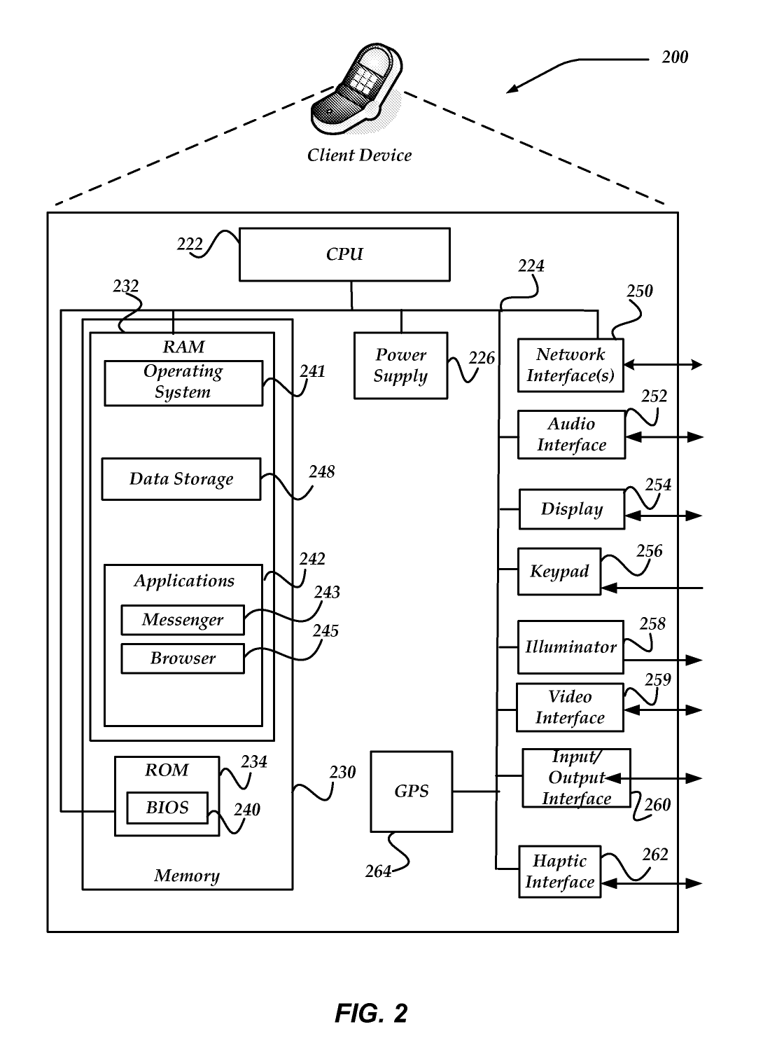

One embodiment of a client device usable as one of client devices 101-105 is described in more detail below in conjunction with FIG. 2. Generally, however, client devices 102-104 may include virtually any computing device capable of receiving and sending a message over a network, such as wireless network 110, wired networks, satellite networks, virtual networks, or the like. Such devices include wireless devices such as, cellular telephones, smart phones, display pagers, radio frequency (RF) devices, infrared (IR) devices, Personal Digital Assistants (PDAs), handheld computers, laptop computers, wearable computers, tablet computers, integrated devices combining one or more of the preceding devices, or the like. Client device 101 may include virtually any computing device that typically connects using a wired communications medium such as telephones, televisions, video recorders, cable boxes, gaming consoles, personal computers, multiprocessor systems, microprocessor-based or programmable consumer electronics, network PCs, or the like. Further, as illustrated, client device 105 represents one embodiment of a client device operable as a television device. In one embodiment, client device 105 may also be portable. In one embodiment, one or more of client devices 101-105 may also be configured to operate over a wired and/or a wireless network.

Client devices 101-105 typically range widely in terms of capabilities and features. For example, a cell phone may have a numeric keypad and a few lines of monochrome LCD display on which only text may be displayed. In another example, a web-enabled client device may have a touch sensitive screen, a stylus, and several lines of color display in which both text and graphics may be displayed.

A web-enabled client device may include a browser application that is configured to receive and to send web pages, web-based messages, or the like. The browser application may be configured to receive and display graphics, text, multimedia, or the like, employing virtually any web-based language, including a wireless application protocol messages (WAP), or the like. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), or the like, to display and send information.

Client devices 101-105 also may include at least one other client application that is configured to receive information and other data from another computing device. The client application may include a capability to provide and receive textual content, multimedia information, audio information, or the like. The client application may further provide information that identifies itself, including a type, capability, name, or the like. In one embodiment, client devices 101-105 may uniquely identify themselves through any of a variety of mechanisms, including a phone number, Mobile Identification Number (MIN), an electronic serial number (ESN), mobile device identifier, network address, or other identifier. The identifier may be provided in a message, or the like, sent to another computing device.

In one embodiment, client devices 101-105 may further provide information useable to detect a location of the client device. Such information may be provided in a message, or sent as a separate message to another computing device.

Client devices 101-105 may also be configured to communicate a message, such as through email, Short Message Service (SMS), Multimedia Message Service (MMS), instant messaging (IM), internet relay chat (IRC), Mardam-Bey's IRC (mIRC), Jabber, or the like, between another computing device. However, the present invention is not limited to these message protocols, and virtually any other message protocol may be employed.

Client devices 101-105 may further be configured to include a client application that enables the user to log into a user account that may be managed by another computing device. Information provided either as part of a user account generation, a purchase, or other activity may result in providing various customer profile information. Such customer profile information may include, but is not limited to purchase history, current telecommunication plans about a customer, and/or behavioral information about a customer and/or a customer's activities.

Wireless network 110 is configured to couple client devices 102-104 with network 111. Wireless network 110 may include any of a variety of wireless sub-networks that may further overlay stand-alone ad-hoc networks, or the like, to provide an infrastructure-oriented connection for client devices 102-104. Such sub-networks may include mesh networks, Wireless LAN (WLAN) networks, cellular networks, or the like.

Wireless network 110 may further include an autonomous system of terminals, gateways, routers, or the like connected by wireless radio links, or the like. These connectors may be configured to move freely and randomly and organize themselves arbitrarily, such that the topology of wireless network 110 may change rapidly.

Wireless network 110 may further employ a plurality of access technologies including 2nd (2G), 3rd (3G), 4th (4G) generation radio access for cellular systems, WLAN, Wireless Router (WR) mesh, or the like. Access technologies such as 2G, 2.5G, 3G, 4G, and future access networks may enable wide area coverage for client devices, such as client devices 102-104 with various degrees of mobility. For example, wireless network 110 may enable a radio connection through a radio network access such as Global System for Mobile communication (GSM), General Packet Radio Services (GPRS), Enhanced Data GSM Environment (EDGE), Wideband Code Division Multiple Access (WCDMA), Bluetooth, or the like. Further, wireless network 110 may be configured to enable use of a short message service center (SMSC) as a network element in a mobile telephone network, within wireless network 110. Thus, wireless network 110 enables the storage, forwarding, conversion, and delivery of SMS messages. In essence, wireless network 110 may include virtually any wireless communication mechanism by which information may travel between client devices 102-104 and another computing device, network, or the like.

Network 111 couples CM device 106, provider service devices 107-108, and client devices 101 and 105 with other computing devices, and allows communications through wireless network 110 to client devices 102-104. Network 111 is enabled to employ any form of computer readable media for communicating information from one electronic device to another. Also, network 111 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router may act as a link between LANs, enabling messages to be sent from one to another. In addition, communication links within LANs typically include twisted wire pair or coaxial cable, while communication links between networks may utilize analog telephone lines, full or fractional dedicated digital lines including T11, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. In essence, network 111 includes any communication method by which information may travel between computing devices.

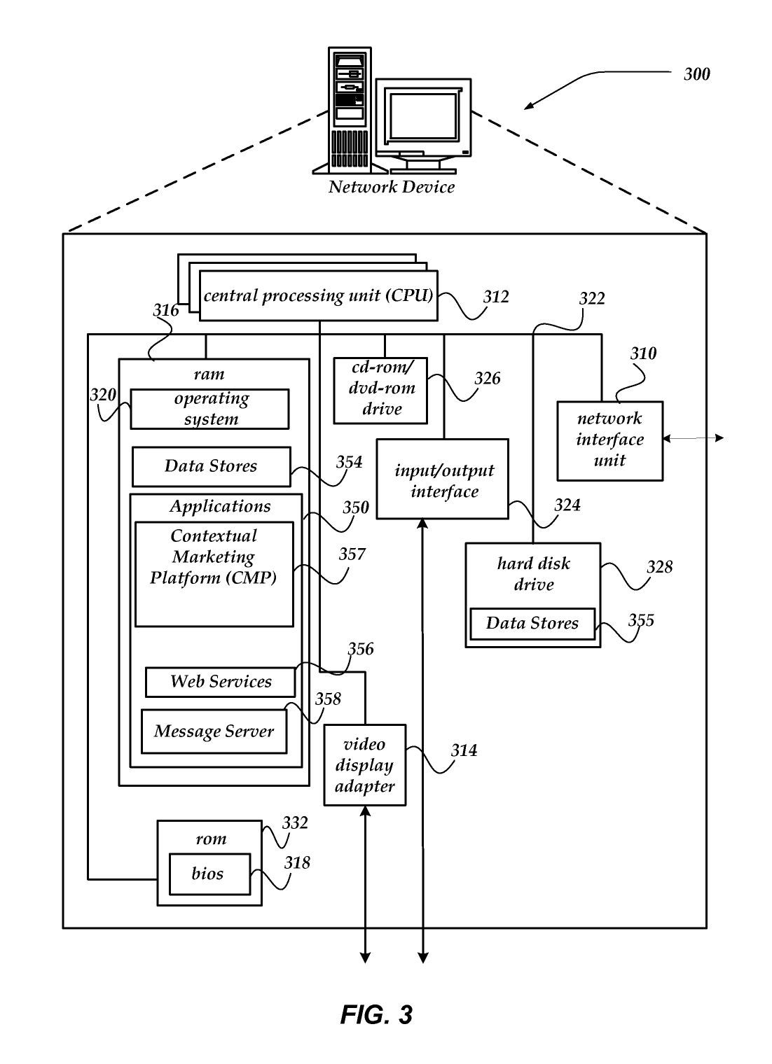

One embodiment of CM device 106 is described in more detail below in conjunction with FIG. 3. Briefly, however, CM device 106 includes virtually any network computing device that is configured to proactively and contextually target offers to customers by performing marketing experiments that adapt and respond automatically based on user behaviors to optimize selected delayed KPIs.

Devices that may operate as CM device 106 include, but are not limited to personal computers, desktop computers, multiprocessor systems, microprocessor-based or programmable consumer electronics, network PCs, servers, network appliances, and the like.

Although CM device 106 is illustrated as a distinct network device, the invention is not so limited. For example, a plurality of network devices may be configured to perform the operational aspects of CM device 106. For example, data collection might be performed by one or more set of network devices, while managing marketing experiments to optimize selected delayed KPIs might be provided by one or more other network devices.

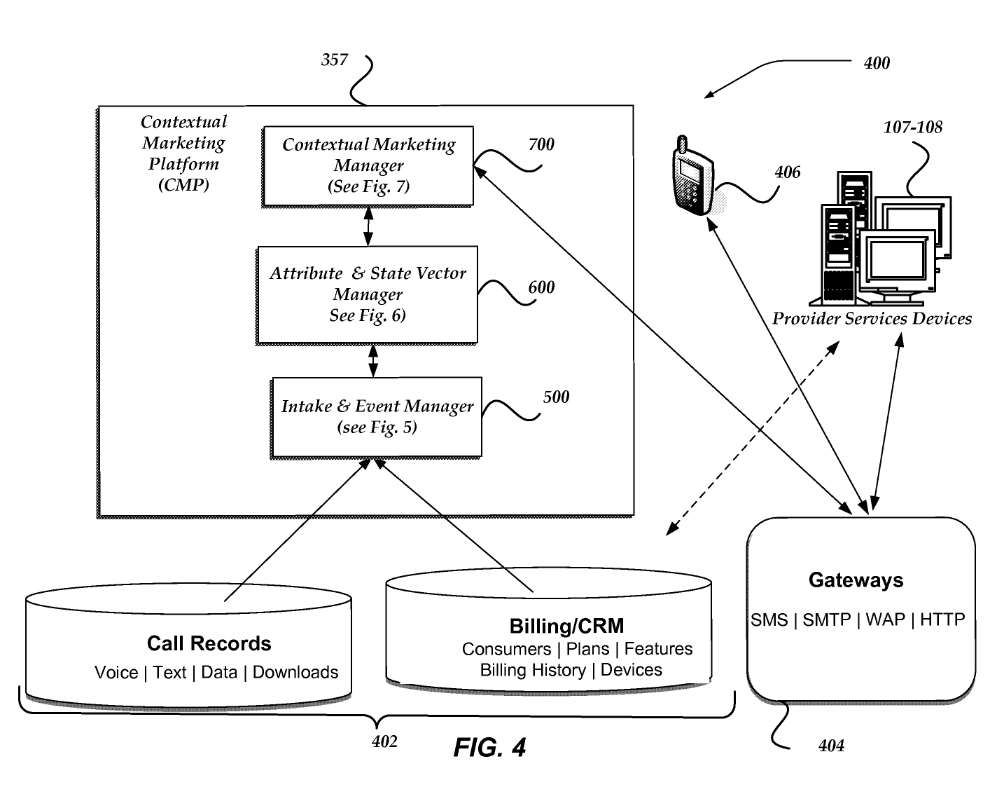

Provider service devices 107-108 include virtually any network computing device that is configured to provide to CM device 106 information including networked services provider information, customer information, and/or other context information for use in generating and selectively presenting a customer with targeted customer offers based on use of the tree and its associated feature measure distributions. In some embodiments, provider service devices 107-108 may provide various interfaces, including, but not limited to those described in more detail below in conjunction with FIG. 4.

### Illustrative Client Environment

FIG. 2 shows one embodiment of client device 200 that may be included in a system implementing the invention. Client device 200 may include many more or less components than those shown in FIG. 2. However, the components shown are sufficient to disclose an illustrative embodiment for practicing the present invention. Client device 200 may represent, for example, one of client devices 101-105 of FIG. 1.

As shown in the figure, client device 200 includes a central processing unit (CPU) 222 in communication with a mass memory 230 via a bus 224. Client device 200 also includes a power supply 226, one or more network interfaces 250, an audio interface 252, video interface 259, a display 254, a keypad 256, an illuminator 258, an input/output interface 260, a haptic interface 262, and an optional global positioning systems (GPS) receiver 264. Power supply 226 provides power to client device 200. A rechargeable or non-rechargeable battery may be used to provide power. The power may also be provided by an external power source, such as an AC adapter or a powered docking cradle that supplements and/or recharges a battery.

Client device 200 may optionally communicate with a base station (not shown), or directly with another computing device. Network interface 250 includes circuitry for coupling client device 200 to one or more networks, and is constructed for use with one or more communication protocols and technologies including, but not limited to, global system for mobile communication (GSM), code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, Bluetooth™, infrared, Wi-Fi, Zigbee, or any of a variety of other wireless communication protocols. Network interface 250 is sometimes known as a transceiver, transceiving device, or network interface card (NIC).

Audio interface 252 is arranged to produce and receive audio signals such as the sound of a human voice. For example, audio interface 252 may be coupled to a speaker and microphone (not shown) to enable telecommunication with others and/or generate an audio acknowledgement for some action. Display 254 may be a liquid crystal display (LCD), gas plasma, light emitting diode (LED), or any other type of display used with a computing device. Display 254 may also include a touch sensitive screen arranged to receive input from an object such as a stylus or a digit from a human hand.

Video interface 259 is arranged to capture video images, such as a still photo, a video segment, an infrared video, or the like. For example, video interface 259 may be coupled to a digital video camera, a web-camera, or the like. Video interface 259 may comprise a lens, an image sensor, and other electronics. Image sensors may include a complementary metal-oxide-semiconductor (CMOS) integrated circuit, charge-coupled device (CCD), or any other integrated circuit for sensing light.

Keypad 256 may comprise any input device arranged to receive input from a user. For example, keypad 256 may include a push button numeric dial, or a keyboard. Keypad 256 may also include command buttons that are associated with selecting and sending images. Illuminator 258 may provide a status indication and/or provide light. Illuminator 258 may remain active for specific periods of time or in response to events. For example, when illuminator 258 is active, it may backlight the buttons on keypad 256 and stay on while the client device is powered. Also, illuminator 258 may backlight these buttons in various patterns when particular actions are performed, such as dialing another client device. Illuminator 258 may also cause light sources positioned within a transparent or translucent case of the client device to illuminate in response to actions.

Client device 200 also comprises input/output interface 260 for communicating with external devices, such as a headset, or other input or output devices not shown in FIG. 2. Input/output interface 260 can utilize one or more communication technologies, such as USB, infrared, Bluetooth™, Wi-Fi, Zigbee, or the like. Haptic interface 262 is arranged to provide tactile feedback to a user of the client device. For example, the haptic interface may be employed to vibrate client device 200 in a particular way when another user of a computing device is calling.

Optional GPS transceiver 264 can determine the physical coordinates of client device 200 on the surface of the Earth, which typically outputs a location as latitude and longitude values. GPS transceiver 264 can also employ other geo-positioning mechanisms, including, but not limited to, triangulation, assisted GPS (AGPS), E-OTD, CI, SAI, ETA, BSS or the like, to further determine the physical location of client device 200 on the surface of the Earth. It is understood that under different conditions, GPS transceiver 264 can determine a physical location within millimeters for client device 200; and in other cases, the determined physical location may be less precise, such as within a meter or significantly greater distances. In one embodiment, however, a client device may through other components, provide other information that may be employed to determine a physical location of the device, including for example, a MAC address, IP address, or the like.

Mass memory 230 includes a RAM 232, a ROM 234, and other storage means. Mass memory 230 illustrates another example of computer readable storage media for storage of information such as computer readable instructions, data structures, program modules, or other data. Computer readable storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

Mass memory 230 stores a basic input/output system (“BIOS”) 240 for controlling low-level operation of client device 200. The mass memory also stores an operating system 241 for controlling the operation of client device 200. It will be appreciated that this component may include a general-purpose operating system such as a version of UNIX, or LINUX™, or a specialized client operating system, for example, such as Windows Mobile™, PlayStation 3 System Software, the Symbian® operating system, Android, Blackberry, iOS, or the like. The operating system may include, or interface with a Java virtual machine module that enables control of hardware components and/or operating system operations via Java application programs.

Memory 230 further includes one or more data storage 248, which can be utilized by client device 200 to store, among other things, applications 242 and/or other data. For example, data storage 248 may also be employed to store information that describes various capabilities of client device 200, as well as store an identifier. The information, including the identifier, may then be provided to another device based on any of a variety of events, including being sent as part of a header during a communication, sent upon request, or the like. In one embodiment, the identifier and/or other information about client device 200 might be provided automatically to another networked device, independent of a directed action to do so by a user of client device 200. Thus, in one embodiment, the identifier might be provided over the network transparent to the user.

Moreover, data storage 248 may also be employed to store personal information including but not limited to contact lists, personal preferences, purchase history information, use information that might include how and/or when a product or service is used, user demographic information, behavioral information, or the like. At least a portion of the information may also be stored on a disk drive or other storage medium (not shown) within client device 200.

Applications 242 may include computer executable instructions which, when executed by client device 200, transmit, receive, and/or otherwise process messages (e.g., SMS, MMS, IM, email, and/or other messages), multimedia information, and enable telecommunication with another user of another client device. Other examples of application programs include calendars, browsers, email clients, IM applications, SMS applications, VOIP applications, contact managers, task managers, transcoders, database programs, word processing programs, security applications, spreadsheet programs, games, search programs, and so forth. Applications 242 may include, for example, messenger 243, and browser 245.

Browser 245 may include virtually any client application configured to receive and display graphics, text, multimedia, and the like, employing virtually any web based language. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), and the like, to display and send a message. However, any of a variety of other web-based languages may also be employed.

Messenger 243 may be configured to initiate and manage a messaging session using any of a variety of messaging communications including, but not limited to email, Short Message Service (SMS), Instant Message (IM), Multimedia Message Service (MMS), internet relay chat (IRC), mIRC, and the like. For example, in one embodiment, messenger 243 may be configured as an IM application, such as AOL Instant Messenger, Yahoo! Messenger, .NET Messenger Server, ICQ, or the like. In one embodiment messenger 243 may be configured to include a mail user agent (MUA) such as Elm, Pine, MH, Outlook, Eudora, Mac Mail, Mozilla Thunderbird, or the like. In another embodiment, messenger 243 may be a client application that is configured to integrate and employ a variety of messaging protocols. Messenger 243, browser 245, or other communication mechanisms that may be employed by a user of client device 200 to receive selectively targeted offers of a product/service based on selection process described in more detail below.

### Illustrative Network Device Environment

FIG. 3 shows one embodiment of a network device, according to one embodiment of the invention. Network device 300 may include many more components than those shown. The components shown, however, are sufficient to disclose an illustrative embodiment for practicing the invention. Network device 300 may represent, for example, CM device 106 of FIG. 1.

Network device 300 includes one or more central processing unit (CPU) 312, video display adapter 314, and a mass memory, all in communication with each other via bus 322. The mass memory generally includes RAM 316, ROM 332, and one or more permanent (non-transitory) mass storage devices, such as hard disk drive 328, tape drive, optical drive, and/or floppy disk drive. The mass memory stores operating system 320 for controlling the operation of network device 300. Any general-purpose operating system may be employed. Basic input/output system (“BIOS”) 318 is also provided for controlling the low-level operation of network device 300. As illustrated in FIG. 3, network device 300 also can communicate with the Internet, or some other communications network, via network interface unit 310, which is constructed for use with various communication protocols including the TCP/IP protocol. Network interface unit 310 is sometimes known as a transceiver, transceiving device, or network interface card (NIC).

The mass memory as described above illustrates another type of non-transitory computer-readable device, namely physical computer storage devices. Computer readable storage devices may include volatile, nonvolatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory, physical devices which can be used to store the desired information and which can be accessed by a computing device.

The mass memory also stores program code and data. For example, mass memory might include data store 354. Data store 354 may be include virtually any mechanism usable for store and managing data, including but not limited to a file, a folder, a document, or an application, such as a database, spreadsheet, or the like. Data store 354 may manage information that might include, but is not limited to web pages, information about customers to a telecommunications service provider, identifiers, profile information, event data, behavioral data, state vectors, business and/or marketing rules, constraints, treatment data, reports, and any of a variety of data associated with a user, message, or experiment, and/or marketer, as well as scripts, applications, applets, and the like. it is noted that while data stores 354 are illustrated within memory 316, data stores 354 may also be stored in other locations within network device 300, including but not limited to cd-rom/dvd-rom drive 326, hard disk drive 328, or even on another network device similar to network device 300. Moreover, data may be distributed across a plurality of data stores such as data stores 354 and/or 355.

One or more applications 350 may be loaded into mass memory and run on operating system 320 using CPU 312. Examples of application programs may include transcoders, schedulers, calendars, database programs, word processing programs, HTTP programs, customizable user interface programs, IPSec applications, encryption programs, security programs, VPN programs, web servers, account management, games, media streaming or multicasting, and so forth. Applications 350 may include web services 356, Message Server (MS) 358, and Contextual Marketing Platform (CMP) 357.

Web services 356 represent any of a variety of services that are configured to provide content, including messages, over a network to another computing device. Thus, web services 356 include for example, a web server, messaging server, a File Transfer Protocol (FTP) server, a database server, a content server, or the like. Web services 356 may provide the content including messages over the network using any of a variety of formats, including, but not limited to WAP, HDML, WML, SMGL, HTML, XML, cHTML, xHTML, or the like. In one embodiment, web services 356 might interact with CMP 357 to enable a networked services provider to track customer behavior, and/or provide contextual offerings based in part on marketing experiments that are directed towards optimizing selectable KPIs.

Message server 358 may include virtually any computing component or components configured and arranged to forward messages from message user agents, and/or other message servers, or to deliver messages to a local message store, such as data stores 354-355, or the like. Thus, message server 358 may include a message transfer manager to communicate a message employing any of a variety of email protocols, including, but not limited, to Simple Mail Transfer Protocol (SMTP), Post Office Protocol (POP), Internet Message Access Protocol (IMAP), NNTP, Session Initiation Protocol (SIP), or the like.

However, message server 358 is not constrained to email messages, and other messaging protocols may also be managed by one or more components of message server 358. Thus, message server 358 may also be configured to manage Short Message Service (SMS) messages, IM, MMS, IRC, mIRC, or any of a variety of other message types. In one embodiment, message server 358 may also be configured to interact with CMP 357 and/or web services 356 to provide various communication and/or other interfaces useable to receive provider, customer, and/or other information useable to determine and/or provide contextual customer offers.

However, it should be noted that messages may be provided to a customer service call center, where the messages may be outbound communicated to a customer, for example, by a human, or be integrated into an inbound conversation between a customer and an agent. The messages, may, for example, be a display advertising message shown on a service provider's customer portal, or in a user's browser on their client device. Moreover, messages may also be sent using any of a variety of protocols to the client device, including, but not limited, for example, via Unstructured Supplementary Service Data (USSD).

One embodiment of CMP 357 is described in more detail below in conjunction with FIGS. 4-12. However, briefly, CMP 357 is configured to receive various historical and behavioral data from networked services providers about their customers, including customer profiles, billing records, usage data, purchase data, types of mobile devices, and the like. CMP 357 may then perform machine learning analysis including performing marketing experiments that identify a market offering to provide to a particular customer, where the offering is directed towards optimizing a selectable KPI for a telecommunications service provider.

### Illustrative Architecture

FIG. 4 shows one embodiment of an architecture useable to perform marketing of contextual offers to be delivered to a customer based on an ordered list of treatments for a given customer (user), that is generated by ranking the treatments for which the given customer is eligible, based on a machine learning model that optimizes predicted KPIs for each treatment; and then uses historical data to enforce experimental constraints that seek to place the customer into a given experiment.

Architecture 400 of FIG. 4 may include many more components than those shown. The components shown, however, are sufficient to disclose an illustrative embodiment for practicing the invention. Architecture 400 may be deployed across components of FIG. 1, including, for example, CM device 106, client devices 101-105, and/or provider services 107-108.

Architecture 400 is configured to make selection decisions for marketing experiments that seek to optimize delayed or long-term KPIs. A customer/user is selectively placed into an experiment to receive (or not) a given user experience that is associated with a treatment within the marketing experiment based on data for the given customer/user that enforces experimental constraints and business rules for a telecommunications service provider. Results of the marketing experiment are then fed back into CMP 357 to automatically learn and adapt to how treatments influence the KPIs of interest.

Not all the components shown in FIG. 4 may be required to practice the invention and variations in the arrangement and type of the components may be made without departing from the spirit or scope of the subject innovation. As shown, however, architecture 400 includes a CMP 357, networked services provider (NSP) data stores 402, communication channel or communication channels 404, and client device 406.

Client device 406 represents a client device, such as client devices 101-105 described above in conjunction with FIGS. 1-2. NSP data stores 402 may be implemented within one or more services 107-108 of FIG. 1. As shown, NSP data stores 402 may include a Billing/Customer Relationship Management (CRM) data store, and a Network Usage Records data store. However, the subject innovation is not limited to this information, and other types of data from networked services providers may also be used. The Billing/CRM data may be configured to provide such historical data as a customer's profile, including their billing history, customer service plan information, service subscriptions, feature information, content purchases, client device characteristics, and the like. Usage Records may provide various historical data as well as current data including but not limited to network usage record information including voice, text, internet, download information, media access, product and/or service use behaviors, and the like. NSP data stores 402 may also provide information about a time when such communications occur, as well as a physical location for which a customer might be connected to during a communication, and information about the entity to which a customer is connecting. Such physical location information may be determined using a variety of mechanisms, including for example, identifying a cellular station that a customer is connected to during the communication. From such connection location information, an approximate geographic or relative location of the customer may be determined. NSP data may further provide information about whether a user received an offer (treatment), and whether or not they responded to that offer (treatment), when, and how. Thus, NSP data may provide data usable to determine a feature measure's value, directly or indirectly.

CMP 357 is streamlined to quickly identify user context changes that are relevant to treatment eligibilities, experiments and selected KPIs, thus accelerating the time-to-treatment of CMP 357 and maximizing the potential to positively impact selected KPIs. Only a small percentage of the massive amount of incoming data might be processed immediately. The remaining records may be processed from a buffer to take advantage of processing power efficiently over a period of time. As the raw data is processed into state vectors of attributes, treatment eligibilities, ranking models, distribution data, and other supporting data, the raw data, and/or results of the processing on the raw data may be stored for later use. However, it should be noted that CMP 357 is configured not to leave any event transactional data ‘on the floor.’ Rather, CMP 357 is directed towards being capable of analyzing data that may not appear in a common set, but appears in a particular case, so that unanticipated actions or results may also be employed and used to further adapt the system. CMP 357 is also directed towards being capable of analyzing historic data so that unanticipated insights may also be employed and used to further adapt the system.

Communication channels 404 include one or more components that are configured to enable network devices to deliver and receive interactive communications with a customer. In one embodiment, communication channels 404 may be implemented within one or more of provider services 107-108, and/or client devices 101-105 of FIG. 1, and/or within networks 110 and/or 111 of FIG. 1.

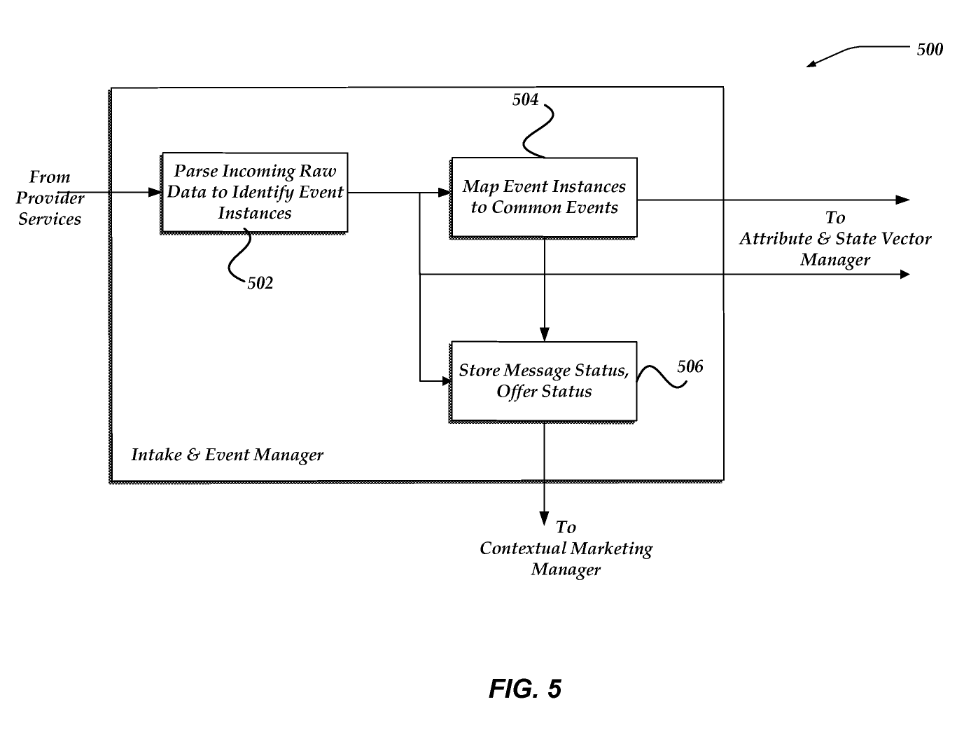

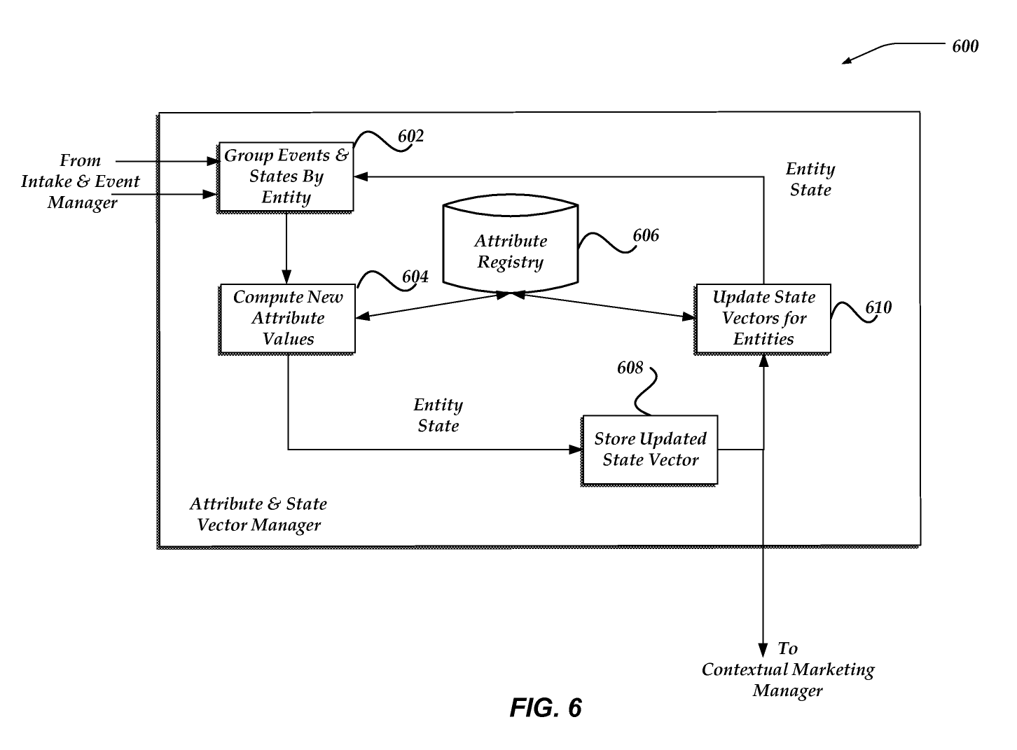

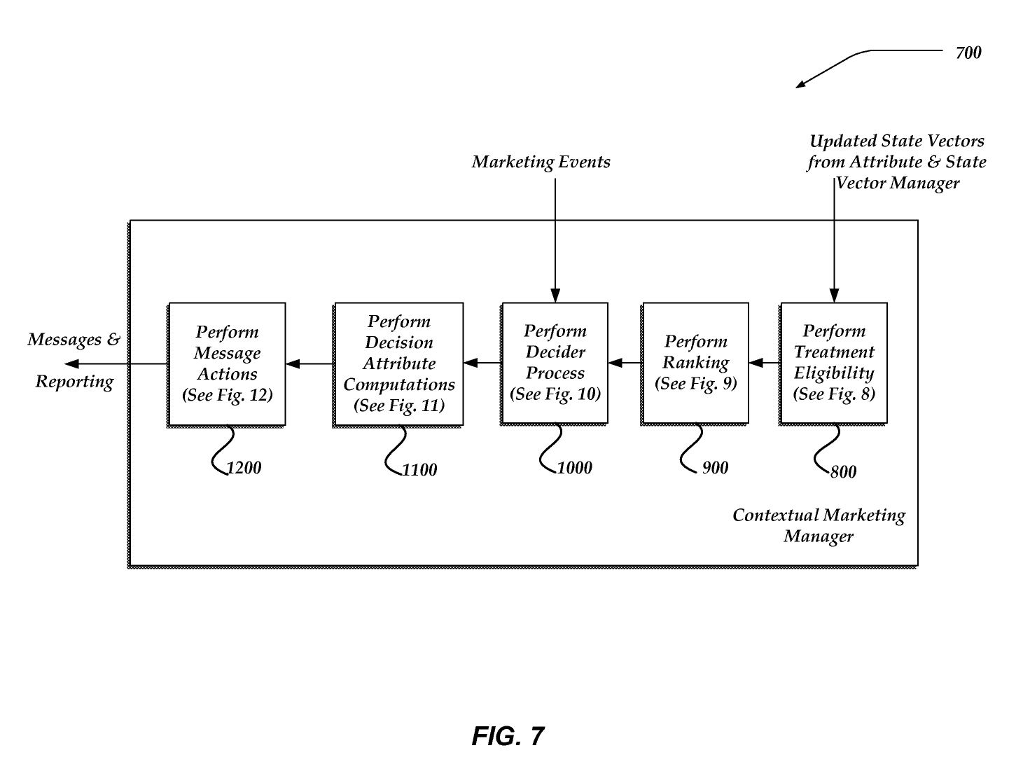

The various components of CMP 357 are described further below. Briefly, however, CMP 357 is configured to receive customer data from NSP data stores 402. CMP 357 may then employ intake & event manager 500 to parse and/or store the incoming data. One embodiment of intake & event manager 500 is described in more detail below in conjunction with FIG. 5. The data may then be provided to attribute & state vector manager 600, which may compute various additional attributes and manage updates to state vectors for entities (customer/users) within the system. One embodiment of attribute & state vector manager 600 is described in more detail below in conjunction with FIG. 6. Updated state vectors are further provided to Contextual Marketing Manager (CMM) 700, which is described in more detail below in conjunction with FIG. 7. Briefly, however, CMM 700 employs a machine learning ranking model that ranks eligible treatments based in part on randomly selecting expected/predicted feature measure or KPI lifts of subjecting a particular user to a particular treatment. The ordered ranking for each customer/user is then validated by a decider process that seeks to place customers within one or more of a control group or target group for each of the rank ordered treatments for which the customer/user is eligible. In some embodiments, it may be determined that a given customer/user is not validly allowed to be placed within a control or target group for a given treatment, based on possible negative interactions with previous treatments to which the customer has been or is currently being subjected. A message is then prepared and sent based on the validated decisions to validated customers/users, where the message operates within a given treatment for an experiment.

It should be noted that the components shown in CMP 357 of FIG. 4 are configured to execute as multiple asynchronous and independent processes, coordinated through an interchange of data at various points within the process. As such, it should be understood that managers 500, 600, and 700 may operate within separate network devices, such as multiple network devices 300, within the same network device within separate CPUs, within a cluster computing architecture, a master/slave architecture, or the like. In at least one embodiment, the selected computing architecture may be specially configured to optimize a performance of the manager executing within it. Moreover, it should be noted that while managers 500, 600, and 700 are described as processes, one or more of the sub-processes within any of the managers 500, 600, or 700 may be fully implemented within hardware, or executed within an application-specific integrated circuit (ASIC), that is, an integrated circuit that is customized for a particular task.

FIGS. 5-12 illustrate various embodiments of components described above briefly within FIG. 4. It should be noted that these components of FIG. 4 may include many more or less components than those shown in FIGS. 5-12. The components shown in FIGS. 5-12, however, are sufficient to disclose illustrative embodiments for practicing the invention.

FIG. 5 shows one embodiment of an intake & event manager (IEM) 500 usable within the CMP 357 of FIG. 4. Briefly, IEM 500 provides a framework for accessing raw data files that may include transactional and/or behavioral data for various entities, including customers/users of a telecommunications service provider.

IEM 500 may receive data as described above in conjunction with FIG. 4. IEM 500 may then employ a sub-process 502 to parse incoming raw data to identify event instances, locate new files, and perform any copying of the files into various storage locations and registries. Parsing may include, among other actions, matching one or more events from a given file to one or more entities, extracting particular event types, event instances, or the like. Any data translations or registrations may also be performed upon the incoming data at sub-process 502. The processed data may then be stored by sub-process 506, including the storing of various message statuses, offer statuses, and the like that may be related to a given experiment. The data is also provided to sub-process 504, where various event instances may be identified and mapped to common events. For example, in one embodiment, a telecommunications service provider may identify events, or other types of data using a particular provider's centric terminology, form, format, or the like. Sub-process 504 may examine the incoming event instances, and so forth, to generate common events with common terminology, form, formats, and so forth, to be provider agnostic. The results of sub-process 504 may also be provided to sub-process 506 for storage. As an aside, the data stores for IEM 500 may be local stores (not shown) or data stores such as those described in conjunction with FIG. 3. The output of IEM 500 may also be provided to CMM 700 of FIG. 4 and/or Attribute & State Vector Manager (ASVM) 600 of FIG. 4.

FIG. 6 shows one embodiment of ASVM 600 usable within the CMP of FIG. 4. It is noted that while many attributes for a message, an entity (customer/user) may be directly obtained from the raw data or as a result of actions performed within IEM 500, there are some attributes that may also be computed or otherwise derived. ASVM 600 therefore is arranged to, in part, compute attributes for entities. ASVM 600 may also update computations given unseen data, current state data, or the like, to compute a new state. ASVM 600 may also support the ability to include aggregate values into computations, as well as compute recursive data, complex data, convert some types of data into other formats for use within subsequent computations, or the like.

As shown in FIG. 6, then ASVM 600 received data from IEM 500 at sub-process 602, wherein the received data may be grouped by entity. Thus, events, state data, and so forth may be organized by entity in one embodiment. The results may flow to sub-process 604 where derived attributes may be computed and provided to sub-process 608 and further to sub-process 610, to store and/or update state vectors for entities, respectively.

Briefly, sub-process 604 may compute a variety of attributes, including, but not limited to recursive independent attributes, attributes having complex forms, attributes that may be computed from predictive models, user clusters, including recharge (of a mobile device) time series clusters, usage histogram clusters, cluster scoring, or the like. Computed attributes may also include values constituting of a category, cyclical values, or the like. In any event, the computed attributes may then be used to update state vectors for an entity, message, or the like, which may be performed by sub-processes 610 and 608. The updated state vectors may then be extracted by sub-process 610 from the data stores, and provided to sub-process 602, and/or used to further update attribute registry 606.

While shown within ASVM 600, attribute registry 606 may actually reside in another location external to ASVM 600. However, attribute registry 606 is illustrated merely to show that data from the registry may be used by different sub-processes of ASVM 600. For example, among other things, attribute registry 606 may provide various event data requirement used to provide data for initialization of an attribute or to derive attributes that might be computed, for example, from ‘scratch’, or the like. Attribute registry 606 may also store and thereby provide attribute dependency data, indicating, for example, whether an attribute is dependent upon another attribute, whether a current dependency state is passed to attributes at a computation time, whether dependencies dictate a computation order, or the like.

It is noted that storage of state vector data at sub-process 608 may also include storing current state data that is used in marketing, as well as historical state data for a given entity. Output of ASVM 600 may flow, among other places to CMM 700 of FIG. 4.

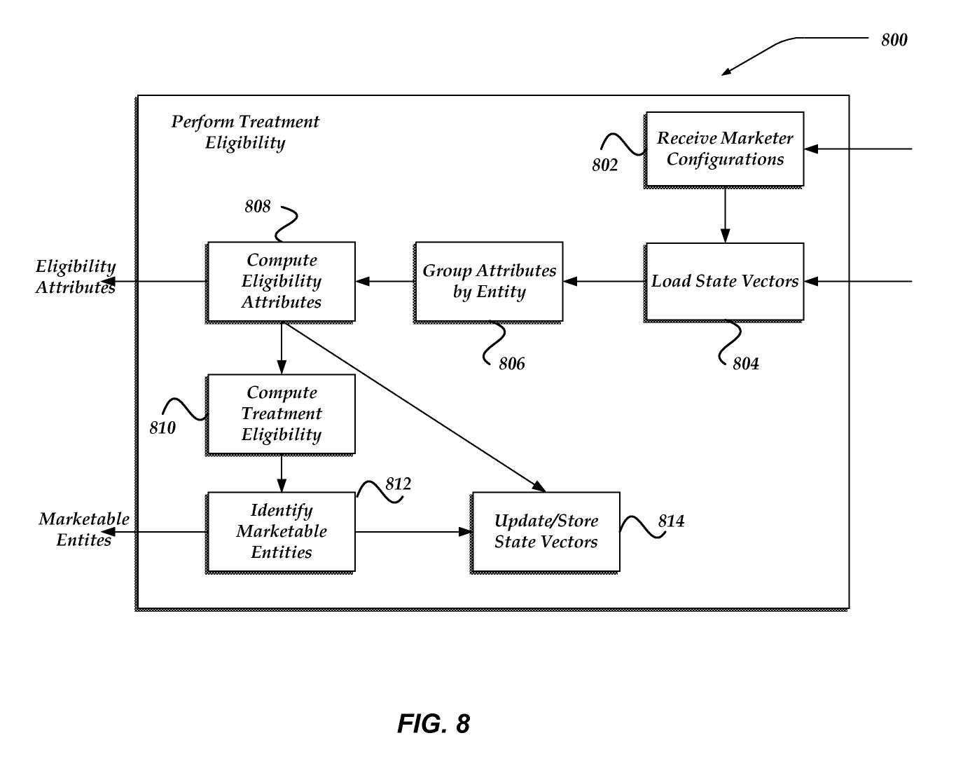

FIG. 7 shows one embodiment of the contextual marketing manager (CMM) 700 usable within the CMP of FIG. 4. Each of the sub-processes shown in FIG. 7 is described in more detail below in conjunction with one of FIGS. 8-12. Briefly, however, CMM 700 of FIG. 7 is configured to perform adaptive analysis to identify treatments for which a customer may be eligible to receive (sub-process 800), and rank order those treatments based on a predictive impact of each treatment on selected KPIs (sub-process 900). A decider process (sub-process 1000) within CMM 700 then employs the rank ordered treatments for each customer in conjunction with a set of experimental constraints and marketing events to ensure that an adaptive experimental design is maintained. The output of the decider process includes a validated assignment of each entity to a control group, target group, or no group for each treatment, which is then used by sub-process 1200 to compose and send various messages to a subset of customers, and by sub-process 1100 to update various decision attributes.

FIG. 8 shows one embodiment of a component usable within the CMM of FIG. 7 to perform treatment eligibility. Briefly, treatment eligibility process 800 of FIG. 8 is directed to provide a framework for computing treatment eligibility based on a state vectors and a marketer's intent. Thus, treatment eligibility process 800 enables the configuration of a marketer's intent, and execution of that intent over a subscriber state space. The output of the process is treatment eligibilities that identify for each entity (customer/user) one or more treatments for which the entity is eligible to receive. This is directed to cover a point-in-time execution of the marketer's intent, including global contact rules and/or other rule types over a given telecommunication service providers' subscriber base. It is noted that other rules and/or constraints that may not include marketer intent may be used to also filter treatment eligibilities, in this, or another process.

As shown, therefore, within eligibility process 800, the marketer's configurations, rules, and constraints for an experiment may be received by sub-process 802. Additionally, state vectors are received (or otherwise loaded) by sub-process 804, based at least in part on the marketer's configurations from sub-process 802. The results of sub-process 804 are provided to sub-process 806, where attributes may be grouped by entity, and then passed to sub-process 808 where eligibility attributes are computed using the marketer's configurations, eligibility attributes being user attributes computed immediately prior to treatment eligibility computation, the use of which is to ensure that the treatment eligibility computation cannot violate certain aspects of the marketer's intent due to out-of-date state vectors. Output from sub-process 808 may be provided to, among other places, to sub-process 814, to update and store the updated state vectors; and to sub-process 810, where treatment eligibility is computed. Briefly, at sub-process 810, the marketers' rules, constraints, and so forth might be used to enforce contact counts, determine which offers and/or messages are of interest, what describes the offer or message, and so forth.

Non-limiting, non-exhaustive examples of possible marketer's rules and/or constraints might include not providing a particular offer to customers that have not been a customer to this telecommunications service provider for greater than x number of years; constraining eligibility for a particular offer based on geography, service plan, whether the customer is delinquent on payments or not, or any of a variety of other constraints.

The output of sub-process 810 is then fed to sub-process 812, where using the telecommunications services provider's constraints, a list of marketable entities are identified. That is, those entities eligible to receive a given treatment given the entity's attributes and where certain constraints are not violated are identified. An example of such a telecommunications service provider constraint might be subscribers that have opted-out of receiving marketing messages. It is noted that the list of marketable entities does not necessarily define those entities that will finally receive or otherwise participate in an experiment or given a treatment, as other criteria may subsequently be applied that eliminates an entity. The intent of sub-process 812 then is to allow those marketable entities to proceed to the next actions of ranking and decisioning, while preserving the eligibilities computed for non-marketable entities for future analysis. The list of marketable entities for one or more treatments is then provided to process 900.

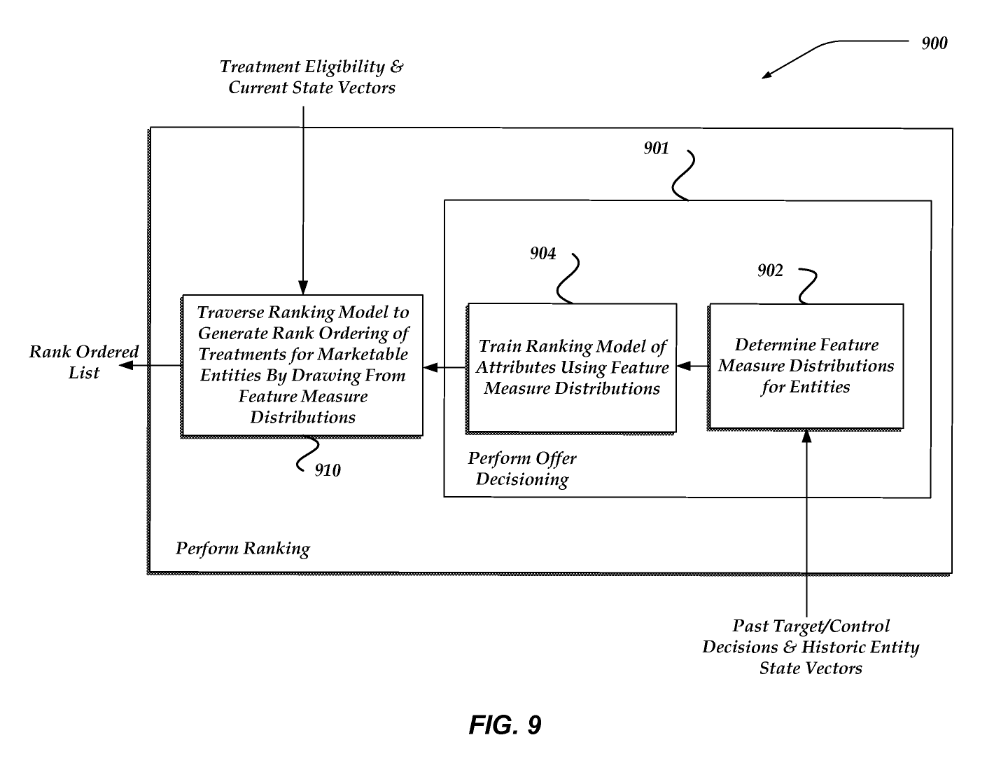

FIG. 9 shows one embodiment of a component usable within the CMM of FIG. 7 to perform ranking of eligibilities. One embodiment of ranking process 900 of FIG. 9 is described in more detail in a corresponding co-pending U.S. patent application Ser. No. 14/264,634, filed on Apr. 29, 2014, entitled “Automated Marketing Offer Decisioning,” by Jesse S. Hersch, Oliver B. Downs, and Luca Cazzanti, and which is further incorporated herein by reference, in its entirety.

However, it is noted that other ranking approaches may also be used to generate a rank ordering of treatment eligibilities for each marketable entity, based at least on a predictive feature measure or KPI lift for a given treatment. Thus, any of a variety of ranking models may be used to generate a ranked ordered list of treatments per entity. Thus, in one embodiment, a tree structure is may be generated as a model useable to maximize an information gain for a message or user attribute; as well as a logistic regression model, a neural network, a support vector machine regression model, a Gaussian Process model, a General Bayesian model, and so forth.

As illustrated in FIG. 9, sub-process 901 performs an offer decisioning action that receives past target and control decisions and historic entity state vectors to determine frequency distributions for various feature measures (KPIs) or interest for target and control groups of entities (sub-process 902). The determined distributions of feature measures (KPIs) are then provided to sub-process 904 along with historical data and state vectors of attributes of entities, messages, and so forth to train/re-train one or more ranking models with decision splits (nodes) within the ranking model being identified based on maximizing an information gain for an attribute, and such that each decision node within the ranking model includes target and control distributions for a feature measure (KPI).

It is noted that where multiple feature measures (KPIs) are of interest to a marketing experiment, one or more ranking models may be generated. A weighted combination of the ranking model data may then be used where a marketer has an interest in optimizing marketing offer decisions over several feature measures (KPIs), and in some embodiments a model may be used to optimize the weightings in the combination. Moreover, a sliding window in which messages for treatments are sent and feature measure results obtained, may be used so as to capture market changes in patterns of users over time.

Once, the ranking model(s) is/are trained by offer decisioning sub-process 901, they may then be used by sub-process 910, along with the treatment eligibilities and marketable entities state vectors. At sub-process 910, various treatment/entity attribute vectors may be used to traverse the one or more ranking models, where the feature measure distributions within the ranking model(s) are used to determine a predicted or expected feature measure (KPI) lift of subjecting that entity to a particular treatment.

That is, in one embodiment, the trained ranking models are traversed for a given treatment/entity (attribute vector), drawing randomly from the feature measure (KPI) distributions at an appropriate decision node within the ranking models to determine an expected/predicted lift for subjecting the entity to a given treatment. In one embodiment, a random drawing is performed from a target distribution and a control distribution at the decision node to obtain the expected/predicted lift as a difference between the randomly drawn values. By drawing randomly from the feature measure distributions, exploration and exploitation of various treatments may be performed to minimize ignoring of treatments that may have an information gain for particular entities.

In any event, at sub-process 910, an ordered list of the treatments is generated based on the predicted or expected lift, for each marketable entity. The ordered list is then provided to decider process 1000 that then determines which treatment, if any, that each entity can validly receive based in part on historical data and other design constraints.

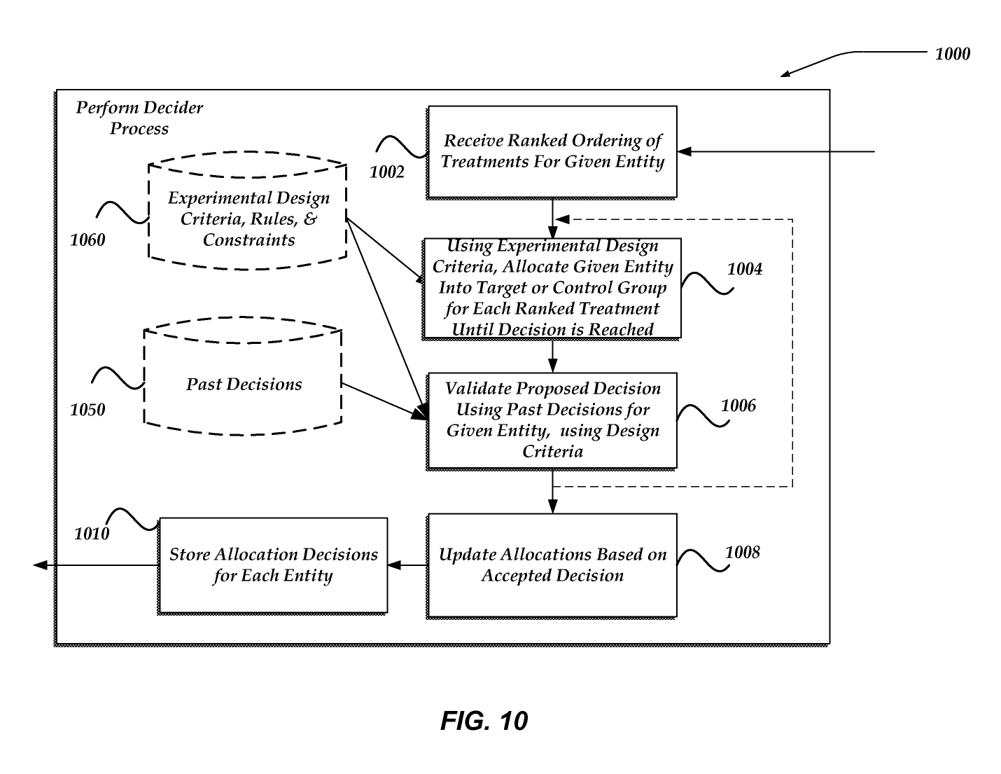

FIG. 10 shows one embodiment of a component usable within the CMM of FIG. 7 to perform a decider process 1000. Briefly, decider process 1000 provides a framework to compute whether and how to use the received ranked treatment eligibilities in marketing to entities, based on experimental design criteria, rules, and constraints, and prior actions and decisions for a given entity. Thus, decider process 1000 is directed towards implementing a decision process that drives both experimental needs for trial marketing options, as well as marketing strategies that may be scaled to an entire subscriber base.

It is noted, as shown using dashed boxes, data stores 1050 and 1060 need not actually reside within decider process 1000, but are illustrated for completeness and to improve understanding of the process. Data stores 1050 and 1060 may therefore be located in a variety of other locations, including those discussed above in conjunction with FIG. 3.

In any event, at sub-process 10002 of FIG. 10, the ranked ordering of treatments for each marketable entity is received from process 900 of FIG. 9. In one embodiment, the ranked ordering for each marketable entity may include, among other information, the ranking for each treatment for which an entity is eligible, an expected/predicted lift for each treatment, and optionally a confidence factor for the ordering and/or predicted lift.

The received ranked ordering is then submitted to sub-process 1004, where experimental design criteria, prior decisions, rules, and constraints, are used for each entity for each ranked treatment, to determine whether to place the entity into a control group or a target group. Using the experimental design inputs, for example, a ratio of target members to control members may be used to place an entity. Other experimental design input might be used to place an entity, including, decision statistics that include counts on how many target allocations have been given out, how many control allocations have been given out, how frequently such allocations have been given out; how large a test group is allowed to be; as well as a variety of other criteria. For example, a rate or frequency of allocation may also be applied. It is noted that the list of entities for allocation that is submitted to sub-process 1004 may be randomized to minimize any inadvertent cross-interactions that might arise by performing allocations of entities that are within a sequential list of entities.

Allocation may also examine the types of treatments to determine, for example, whether two treatments for the entity include different offers, but that the rules that qualify an entity for the offers are identical. For example, two treatments might be based on a recharge by the entity for a given amount, but one treatment offers a credit, while another treatment offers additional messaging, or the like. Given these treatments, the question might arise as to which offer is more likely to generate more lift and hence improve a selected KPI or weighted combination of KPIs? Then given that these two treatments are different, but the rules that qualify an entity for the treatment are the same, then allocation of an entity to a control group could be performed such that the control group might be shared between the two treatments. By analyzing such relationships to allocate an entity to a control group or target group an efficiency of entities and resources may be achieved, providing potentially a unique and novel approach to allocations of entities, by sharing entities across multiple treatments or experiments.

The allocated entities for each treatment are then provided to sub-process 1006, where past decisions, as well as the experimental design criteria, rules, and constraints are used to validate the proposed allocation decision for each entity for each treatment.

Validation may include a complex process of examining selected prior actions or decisions for a given entity and allocation to determine whether there exist negative or adverse interactions or conflicts that might arise. The prior actions or decisions that are used to validate an allocation may be based on how long ago the prior action or decision occurred. For example, it might be decided that actions or decisions that are older than two years, or any other age, might not be used to validate a decision. However, in other instances, because some experiments or treatments may take a long time before a result is observable, the age used may be adaptive based on characteristics of the current treatment, as well as the prior action/decision. Other criteria may also be used, such as whether a prior decision resulted in one decision, and the current treatment undoes or changes significantly that decision; whether an entity is currently within a conflicting treatment; whether there are physical constraints between treatments that might impact each other; whether an entity is assigned to a target group in one treatment but is in a control group for another treatment with a different strategy. Any of a variety of constraints and rules may be applied to validate a decision. For example, it might be determined that interactions between treatments are desirable, to determine whether multiple treatments or a coordinate sequence of treatments increase (or are otherwise synergistic with respect to) a resulting KPI over performing just one of the treatments. Further, as results of the experiments are obtained, the experimental design criteria, rules, and constraints may be modified.

It is noted that based on the validation process an entity assigned to a control or target group for a given treatment allocation might be removed from that group and changed to a different group, or even not assigned to either treatment or control. As an aside, a dashed line is shown suggesting that the sub-processes 1004 and 1006 may loop until a decision is reached for each treatment for each entity. When the entity's allocations have been validated, processing flows to sub-process 1008, where allocations are updated based on the accepted decisions, and then stored for each entity by sub-process 1010, which may in-turn result in updates to state vectors for the entities, as well as updating of other related data stores for each entity, as discussed below.

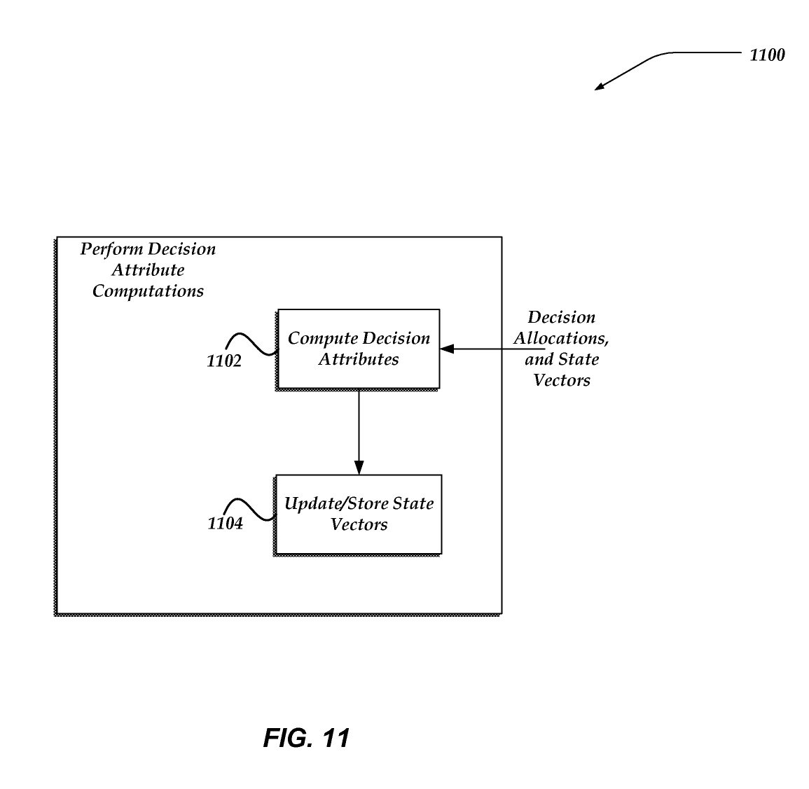

FIG. 11 shows one embodiment of a component usable within the CMM of FIG. 7 to perform decision attribute computations. Briefly, process 1100 of FIG. 11 is configured to receive decision allocations and state vectors and compute any decision attributes (at sub-process 1102) based on the decision allocations for each entity for each treatment. The results of sub-process 1102 may then be provided to sub-process 1104 where the state vectors for each affect entity is then updated and stored.

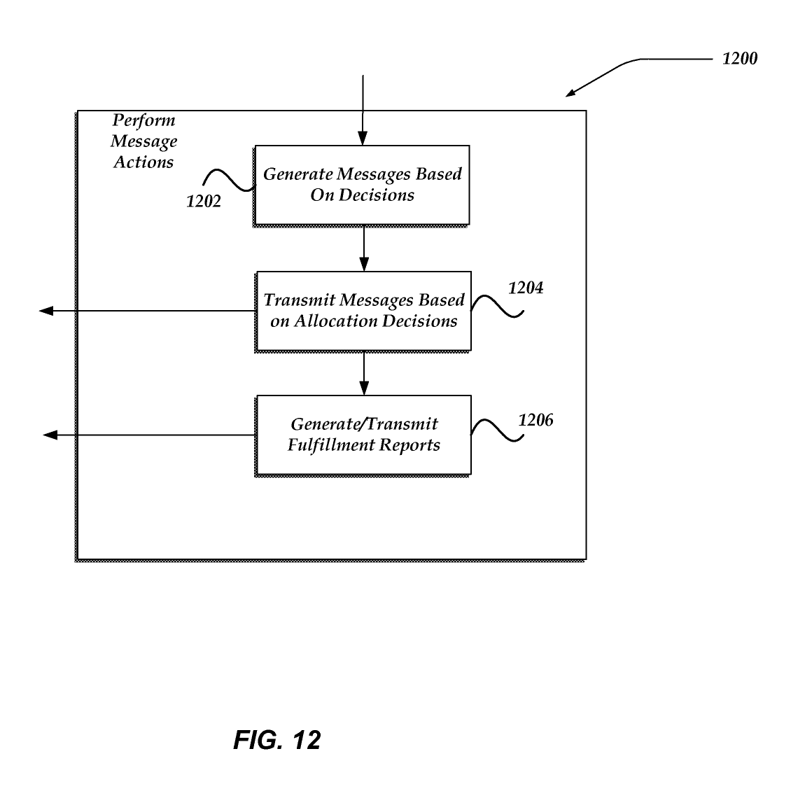

FIG. 12 shows one embodiment of a component usable within the CMM of FIG. 7 to perform message actions. Process 1200 of FIG. 12 receives the decision allocations, information about each treatment, and other data usable to generate messages usable to perform a treatment, experiment, or otherwise provide a contextual marketing offer to an entity (customer/user) for a telecommunications service provider (sub-process 1202). The generated messages may then be transmitted to the entity by sub-process 1204 based on those allocation decisions. It is noted that part of the treatment may include how and/or when a message is transmitted to the entity. Thus, some messages might be transmitted to an entity at once, while others might wait for a given time, occurrence or the like, before being transmitted to the entity. Such actions might be, for example, within the criteria of the treatment or experiment itself. Moreover, such criteria might define whether the message is sent as an SMS message, a voice message, or the like. In any event, at sub-process 1206, a fulfillment report may be generated and transmitted to a telecommunications service provider to indicate a status of a treatment, experiment, a message, or the like. The report may also include any of a variety of other criteria as well.

In any event, as can be seen from the actions and configurations discussed above, results of the messages may be monitored and fed back into the system to enable the system to adapt and refine a marketing strategy. Such feedback loop, as discussed above, may focus on factors that take a long time before a result is observed. For example, while some messages might have a result by the entity that occurs within a short period of time (minutes, hours, or even days) of receiving the message, other messages might take weeks or even months to see the results. The above system and architecture is configured to monitor the long period type treatments as well as short period treatments. However, unlike many traditional systems the above innovations provide a unique and novel approach that enables performing marketing experiments that affect long term behaviors over time of customers.

It will be understood that each block of the processes, and combinations of blocks in the processes, can be implemented by computer program instructions. These program instructions may be provided to a processor to produce a machine, such that the instructions, which execute on the processor, create means for implementing the actions specified in the block or blocks. The computer program instructions may be executed by a processor to cause a series of operational steps to be performed by the processor to produce a computer-implemented process such that the instructions, which execute on the processor to provide steps for implementing the actions specified in the block or blocks. The computer program instructions may also cause at least some of the operational steps shown in the blocks to be performed in parallel. Moreover, some of the steps may also be performed across more than one processor, such as might arise in a multi-processor computer system. In addition, one or more blocks or combinations of blocks in the illustration may also be performed concurrently with other blocks or combinations of blocks, or even in a different sequence than illustrated without departing from the scope or spirit of the subject innovation.

Accordingly, blocks of the illustration support combinations of means for performing the specified actions, combinations of steps for performing the specified actions and program instruction means for performing the specified actions. It will also be understood that each block of the illustration, and combinations of blocks in the illustration, can be implemented by special purpose hardware based systems, which perform the specified actions or steps, or combinations of special purpose hardware and computer instructions.

The above specification, examples, and data provide a complete description of the manufacture and use of the composition of the subject innovation. Since many embodiments of the subject innovation can be made without departing from the spirit and scope of the subject innovation, the subject innovation resides in the claims hereinafter appended.

1-28. (canceled)

29. A non-transitory computer-readable storage device having instructions stored thereon that, in response to execution by a processor unit, cause the processor unit to perform operations including:
tracking, by the processor unit, actions of a plurality of customers of a telecommunications service provider;
analyzing, by the processor unit, the tracked actions to select multiple customers of the plurality for a target group to receive information related to functionality provided by the telecommunications service provider, wherein the selecting of the multiple customers for the target group for the information is based at least in part on a prediction from the tracked actions of those multiple customers that those multiple customers will alter their future actions based on the information;
sending, by the processor unit, messages over one or more networks to client devices of the multiple customers in the target group that include the information;
tracking, by the processor unit, results of sending the messages based at least in part on further actions related to the information that are taken by at least some customers over a period of time; and
updating, based on the tracked results, stored data about the plurality of customers, to adjust future predictions that customers will alter further future actions based on future providing of information.

30. The non-transitory computer-readable storage device of claim 29 wherein the selecting of the multiple customers for the target group includes rank ordering each of the plurality of customers based on a determined expected response of the customer to the information.

31. The non-transitory computer-readable storage device of claim 29 wherein the selecting of the multiple customers for the target group includes determining that those multiple customers are eligible to receive the information based at least in part on attributes of those multiple customers and on rules associated with the information.

32. The non-transitory computer-readable storage device of claim 29 wherein the information includes one of multiple offerings from the telecommunications service provider, and wherein the selecting of the multiple customers includes selecting at least one customer for a control group that is sharable across two or more of the multiple offerings.

33. The non-transitory computer-readable storage device of claim 29 wherein the information includes one of multiple offerings from the telecommunications service provider, and wherein the selecting of the multiple customers includes selecting at least one customer for the target group based at least in part on the at least one customer being previously assigned to a target group for a different offering that is related to the one offering included in the information.

34. The non-transitory computer-readable storage device of claim 29 wherein the tracking of the results includes receiving responses to at least some of the sent messages, and wherein the updating of the stored data includes adaptively refining a ranking model used for the selecting of the multiple customers, and includes selecting at least one customer to receive additional information based in part on the refined ranking model.

35. The non-transitory computer-readable storage device of claim 29 wherein the analyzing of the tracked actions to select the multiple customers is performed to satisfy one or more defined criteria that include at least one of a frequency of assignments to a target group, or a total number of customers for a target group.

36. The non-transitory computer-readable storage device of claim 29 wherein the information includes an offering with incentives for a customer to recharge an account of the customer with the telecommunications service provider, and wherein the operations performed by the processor unit further include generating, the prediction that the multiple customers for the target group will alter their future actions based on the information by electing to recharge their accounts within a defined period of time.

37. The non-transitory computer-readable storage device of claim 36 wherein the information includes a first offering with a first incentive having a monetary credit if a customer recharges their account with the telecommunications service provider and further includes a second offering that provides a second incentive having extra messaging capabilities if a customer recharges their account with the telecommunications service provider, and wherein the operations performed by the processor unit further include comparing results from the first and second offerings to determine which of the first and second incentives produces a larger change in corresponding future actions of customers to recharge their accounts.

38. The non-transitory computer-readable storage device of claim 29 wherein the updating further includes generating one or more of the future predictions that customers will alter future actions by electing to stay customers of the telecommunications service provider for a defined future period of time.

39. The non-transitory computer-readable storage device of claim 29 wherein the updating further includes generating one or more of the future predictions that customers will alter future actions by electing to renew a service from the telecommunications service provider during a defined future period of time.

40. The non-transitory computer-readable storage device of claim 29 wherein the updating further includes generating one or more of the future predictions that customers will alter future actions by making a purchase within a defined future period of time.

41. A computer-implemented method comprising:
tracking, by one or more configured computing systems, actions of a plurality of customers of a service provider in using functionality provided by the service provider;
analyzing, by the one or more configured computing systems, the tracked actions to select multiple customers to include in a target group to receive information related to the functionality provided by the service provider, wherein the selecting of the multiple customers is based at least in part on a prediction from the tracked actions that the multiple customers will alter their future actions in using the functionality of the service provider based on the information;
sending messages, by the one or more configured computing systems over one or more networks to client devices of the multiple customers, that include the information;
tracking, by the one or more configured computing systems and over a period of time after sending the messages, results of providing the information to the multiple customers based at least in part on further actions that are taken by at least some of the multiple customers over the period of time that alter use of the functionality provided by the service provider, wherein the further actions taken by one or more of the at least some customers include altering accounts of the one or more customers with the service provider; and
updating, by the one or more configured computing systems and based on the tracked results, stored data about the multiple customers, to adjust future predictions that the multiple customers will alter further future actions based on future providing of information.

42. The computer-implemented method of claim 41 wherein the tracking of the results includes receiving responses to at least some of the sent messages, wherein the updating of the stored data includes adaptively refining a ranking model used for the selecting of the multiple customers for the target group, and includes selecting at least one customer to receive additional information based in part on the refined ranking model, and wherein the ranking model includes one of a tree, logistic regression model, neural network, support vector regression, Gaussian process regression, or Generalized Bayesian model.

43. The computer-implemented method of claim 41 wherein the information includes one of multiple offerings from the service provider, and wherein the analyzing of the tracked actions is performed for each of multiple distinct offerings that have distinct target groups and further includes selecting one or more additional customers to be part of at least one control group.

44. The computer-implemented method of claim 41 wherein the service provider is a telecommunications service provider, wherein the functionality provided by the service provider includes one or more voice and data communications services, and wherein the method further comprises generating one or more of the future predictions that the multiple customers will alter the further future actions by performing at least one of electing to recharge accounts within a defined future period of time, electing to stay customers of the service provider for a defined future period of time, electing to renew a service from the service provider within a defined future period of time, or making purchases within a defined future period of time.

45. The computer-implemented method of claim 41 wherein the service provider is a retailer and the functionality provided by the service provider includes offering items for purchase by customers, or the service provider is a banking service provider and the functionality provided by the service provider includes one or more banking services, or the service provider is a cable television service provider and the functionality provided by the service provider includes one or more cable television services.

46. A network device, comprising:
a transceiver to send and receive data over a network; and
one or more processors that are operative to perform automated operations including:
tracking actions of a plurality of customers of a telecommunications service provider in using functionality provided by the telecommunications service provider;
analyzing the tracked actions to select multiple customers that are a subset of the plurality to include in a target group to receive information about an offering from the telecommunication service provider related to recharging customer accounts for use in accessing the functionality provided by the telecommunications service provider, wherein the selecting of the multiple customers is based at least in part on a prediction from the tracked actions that the multiple customers will elect to recharge their accounts with the telecommunications service provider in response to the offering;
sending, over the network to client devices of the multiple customers, electronic messages that include the information about the offering;
tracking, over a period of time after sending the electronic messages, results of the offering based at least in part on further actions that are taken by at least some of the multiple customers over the period of time; and
updating, based on the tracked results, stored data about the multiple customers, to adjust future predictions that the multiple customers will alter further future actions based on future providing of information.

47. The network device of claim 46 wherein the tracking of the results includes receiving responses to the sent electronic messages, wherein the updating of the stored data about the multiple customers includes adaptively refining a ranking model based in part on the received responses, wherein the one or more processors are further operative to select at least one other offering to provide to at least one of the multiple customers based in part on the refined ranking model, and to provide the at least one other offering to the at least one customer.

48. The network device of claim 46 wherein the selecting of the multiple customers includes determining that the multiple customers are eligible to receive the offering based at least in part on attributes of the multiple customers and on constraints associated with the offering.
